(19) United States
(12) Patent Application Publication
(10) Pub. No.: US 2010/0110627 A1
(43) Pub. Date: May 6, 2010

(54) THERMAL MODULE CAPABLE OF DISSIPATING HEAT GENERATED BY A PLURALITY OF HEAT SOURCES AND RELATED COMPUTER SYSTEM

(76) Inventor: Hsing-Yu Chiang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/581,887

(22) Filed: Oct. 20, 2009

(30) Foreign Application Priority Data
Nov. 4, 2008 (TW) 097219711

(51) Int. Cl. G06F 1/20; F28D 15/02; F28D 21/00

(52) U.S. Cl. 361/679.48; 361/679.46; 361/679.52; 165/104.26; 165/121; 165/185

(57) ABSTRACT

A thermal module includes a base including a first plate having a first side for connecting with a first heat source so as to conduct heat generated by the first heat source, and a second plate connected to the first plate. A height difference is formed between the first plate and the second plate. The second plate includes a second side opposite to the first side of the first plate for connecting with the second heat source so as to conduct heat generated by the second heat source. The thermal module includes a heat-dissipating device connected to the base for dissipating the heat transmitted to the first plate and for dissipating the heat transmitted to the second plate. A height difference is formed between the first heat source and the second heat source, and the base is positioned between the first heat source and the second heat source.

### BACKGROUND OF THE INVENTION

1. Field of the Invention

The present invention relates to a thermal module and a related computer system, and more particularly, to a thermal module capable of dissipating heat generated by a plurality of heat sources and a related computer system.

2. Description of the Prior Art

In modern information society, computer systems are becoming necessities, such as desktops, notebook computers, servers, and so on. The operation speed of computers is getting faster and faster so that the computer is becoming powerful and is utilized in a wide variety of fields. Therefore, components of the computer generate more heat while processing operations than before. If the heat generated by the components of the computer can not be dissipated effectively, the stability and operation speed of the computer will be reduced.

In addition, a consumer electronic device in the modern society has two major demands. One is microminiaturization, and the other one is diversification. In a period of demanding a smaller product having multi-functions, how to install lots of components in a small casing for providing multi-functions is more important. A computer system capable of outputting high quality images and supporting 3D games is a necessary requirement, and a key point of the computer system is a powerful display card. However, while an image processor of the display card executes an image processing, heat generated by the image processor has increased correspondingly, especially the heat generated enormously by a high level display card or by the image processor processing complicated information, such as a 3D image. Due to constraint of mechanical disposition of internal components on a main board, gaps between slots of the main board and the internal components are narrow so as to constrain the heat generated by the image processor for dissipating. Additionally, a high temperature condition of the display card influences operating stability of the computer systems and decreases service life of the display card, especially for a system host of miniaturization.

In order to solve this problem, an exclusive thermal module is used for dissipating the enormous heat generated by the image processor of the display card. However, there are still other heat sources in the computer systems needing exclusive thermal modules for dissipating heat thereof, such as a central processing unit, a north bridge chip, and so on. If several exclusive thermal modules designed for specific heating components need to be disposed in a small mechanical space, the rest space for disposing other components must be decreased or a dimension of the computer system must be increased resulting in failure of miniaturization. Therefore, design of the thermal module suitable for a smaller inner space of the computer system is an important issue nowadays.

### SUMMARY OF THE INVENTION

According to the claimed invention, a thermal module includes a base having a first side for connecting to a first heat source so as to conduct heat generated by the first heat source, and a second side disposed opposite to the first side for connecting to a second heat source so as to conduct heat generated by the second heat source. The thermal module further includes a heat dissipating device connected to the base for dissipating the heat conducted to the first side of the base from the first heat source and for dissipating the heat conducted to the second side of the base from the second heat source. A first height difference is formed between the first heat source and the second heat source, and the base is disposed between the first heat source and the second heat source.

According to the claimed invention, the base is made of metal material.

According to the claimed invention, the base is made of copper or aluminum material.

According to the claimed invention, the heat dissipating device further includes a heat pipe connected to the base at an end.

According to the claimed invention, the heat dissipating device further includes a plurality of thermal fins connected to the other end of the heat pipe for dissipating heat conducted from the heat pipe.

According to the claimed invention, the heat dissipating device further includes a fan disposed on a side of the plurality of thermal fins for dissipating heat of the plurality of thermal fins.

According to the claimed invention, the base includes a first base plate whereon the first side is disposed, and a second base plate whereon the second side is disposed. The second base plate is connected to the first base plate, and a second height difference is formed between the first base plate and the second base plate.

According to the claimed invention, the first base plate is integrated with the second base plate monolithically.

According to the claimed invention, a computer system includes a main board, a first heat source installed on the main board, a slot disposed on a side of the main board, and an interface card for inserting into the slot. A second heat source is disposed on the interface card, and a first height difference is formed between the first heat source and the second heat source. The computer system further includes a thermal module including a base disposed between the first heat source and the second heat source. The base includes a first side for connecting to the first heat source so as to conduct heat generated by the first heat source, and a second side disposed opposite to the first side for connecting to the second heat source so as to conduct the heat generated by the second heat source. The thermal module further includes a heat dissipating device connected to the base for dissipating the heat conducted to the first side of the base from the first heat source and for dissipating the heat conducted to the second side of the base from the second heat source.

According to the claimed invention, the first heat source is a chip.

According to the claimed invention, the first heat source is a north bridge chip.

According to the claimed invention, the slot is a display card slot, the interface card is a display card, and the second heat source is a display card chip.

According to the claimed invention, the computer system further includes a central processing unit thermal module disposed on a side of the fan and on a side of the plurality of thermal fins, and the fan is used for dissipating heat of the plurality of thermal fins and the central processing unit thermal module.

According to the claimed invention, the computer system further includes a first thermal pad installed between the first side of the base and the first heat source for conducting the heat generated by the first heat source to the first side of the base.

According to the claimed invention, the computer system further includes a second thermal pad installed between the second side of the base and the second heat source for conducting the heat generated by the second heat source to the second side of the base.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a computer system capable of dissipating heat generated by a plurality of heat sources of the present invention.

FIG. 2 is a schematic drawing of a thermal module of the present invention.

FIG. 3 is a sectional view of the thermal module disposed between a first heat source and a second heat source according to a first embodiment of the present invention.

FIG. 4 is a sectional view of the thermal module disposed between the first heat source and the second heat source according to a second embodiment of the present invention.

FIG. 5 is a schematic drawing of a central processing unit thermal module of the present invention.

FIG. 6 is a schematic drawing of the thermal module and the central processing unit thermal module of the present invention.

FIG. 7 is a sectional view of a thermal module disposed between the first heat source and the second heat source according to a third embodiment of the present invention.

### DETAILED DESCRIPTION

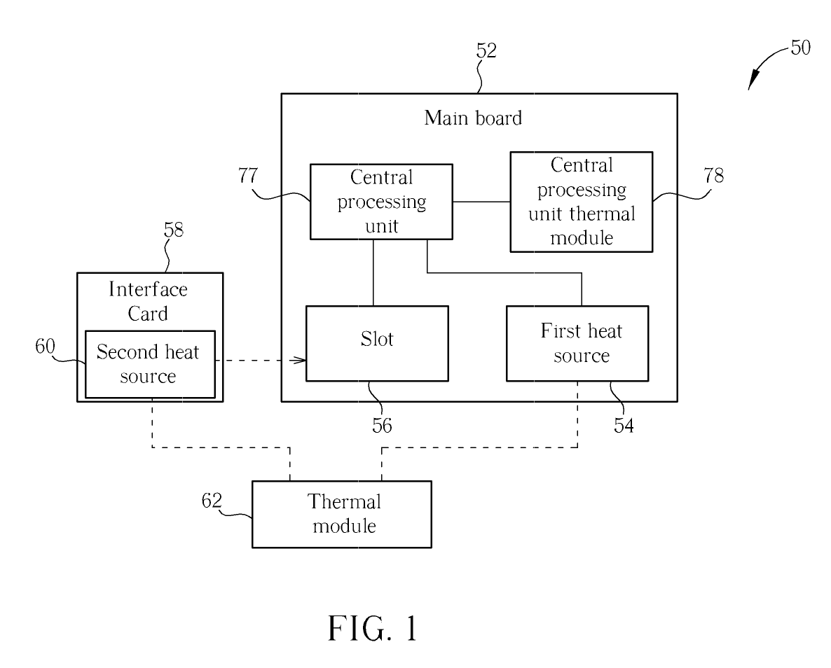

Please refer to FIG. 1. FIG. 1 is a functional block diagram of a computer system 50 capable of dissipating heat generated by a plurality of heat sources of the present invention. The computer system 50 includes a main board 52, a first heat source 54 installed on the main board 52, a slot 56 disposed on a side of the main board 52, an interface card 58 for inserting into the slot 56, and a thermal module 62 for dissipating heat generated by the first heat source 54 of the main board 52 and the second heat source 60 of the interface card 58. The first heat source 54 can be a chip with high power, such as a north bridge chip or a south bridge chip. The slot 56 can be a display card slot, and the interface card 58 can be a display card correspondingly. A second heat source 60 is disposed on the interface card 58, and the second heat source 60 can be a display card chip correspondingly. The interface card 58 can also be a TV tuner card, a wireless network card, a memory, and so on. The computer system 50 further includes a central processing unit 77 electrically connected to the first heat source 54 and the slot 56 so as to control internal components, such as controlling the first heat source 54 or controlling the interface card 58 via the slot 56. The computer system 50 further includes a central processing unit thermal module 78 for dissipating the heat generated by the central processing unit 77.

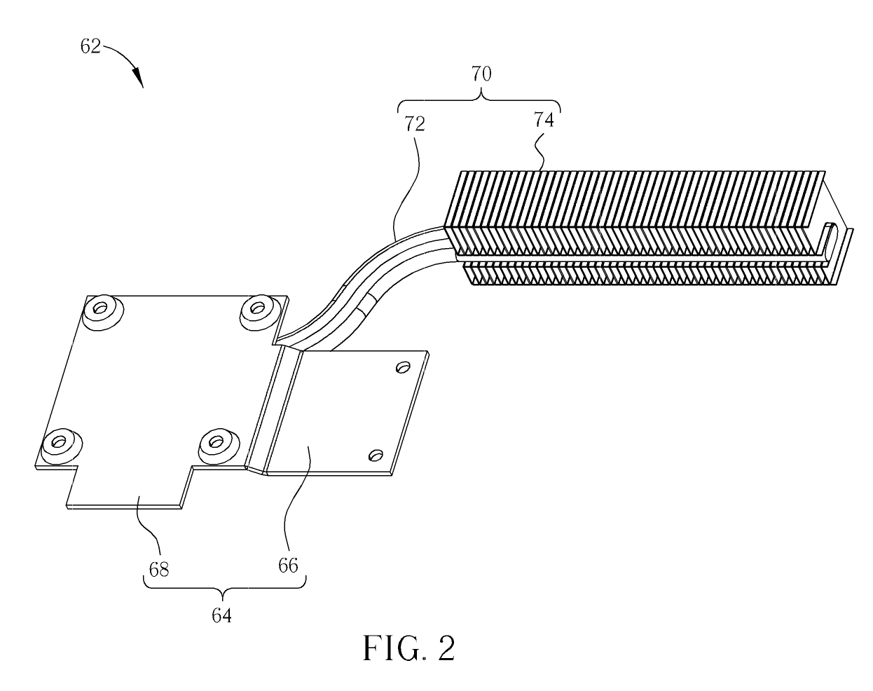

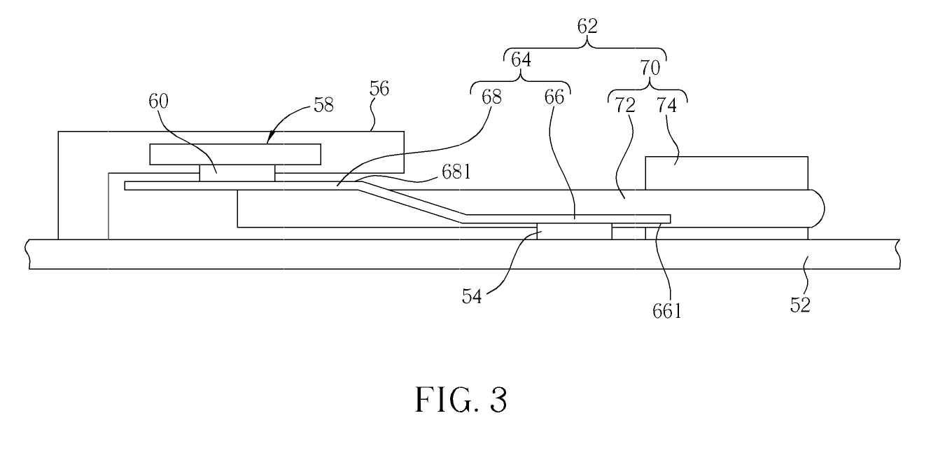

Please refer to FIG. 2 and FIG. 3. FIG. 2 is a schematic drawing of the thermal module 62 of the present invention. FIG. 3 is a sectional view of the thermal module 62 disposed between the first heat source 54 and the second heat source 60 according to a first embodiment of the present invention. The thermal module 62 includes a base 64 including a first base plate 66 whereon a first side 661 is configured for connecting to the first heat source 54 so as to conduct the heat generated by the first heat source 54, and a second base plate 68 connected to the first base plate 66. A second height difference is formed between the first base plate 66 and the second base plate 68 so as to reduce material of the base 64 for cost down. The second base plate 68 includes a second side 681 opposite to the first side 661 of the first base plate 66 for connecting the second heat source 60 so as to conduct the heat generated by the second heat source 60. The first base plate 66 and the second base plate 68 of the base 64 can be integrated monolithically and can be made of metal material, such as copper or aluminum material, so as to increase heat conductivity. The thermal module 62 further includes a heat dissipating device 70 connected to the base 64 for dissipating the heat conducted to the first base plate 66 from the first heat source 54 and for dissipating the heat conducted to the second base plate 68 from the second heat source 60. The heat dissipating device 70 includes a heat pipe 72 connected the base at one end. The heat dissipating device 70 further includes a plurality of thermal fins 74 connected to the other end of the heat pipe 72 for dissipating heat conducted from the heat pipe 72.

In regard to a principle of the thermal device 70, when an end of the heat pipe 72 is disposed on the base 64 as a high temperature end and the other end of heat pipe 72 is disposed on the plurality of heat thermal fins 74 as a low temperature end, the heat pipe 72 starts to conduct the heat. The heat transfer procedure of the heat pipe 72 is provided as follows. First, the heat goes through a wall of a metal pipe and then enters the capillary organization. At this time, the working liquid in the capillary organization starts evaporating into vapor due to being heated. The said vapor moves to the other end of the heat pipe 72. Because the other end of the heat pipe 72 is disposed on the low temperature end, the said vapor arrives at the low temperature end and condenses into liquid again. At this time, the heat is conducted from the evaporated working liquid to an outward heat pipe 72 as the low temperature end via the capillary organization and the metal pipe. Then, the liquid generated during condensation of the said vapor flows back to the high temperature end due to capillary pumping. The heat conducted from the high temperature end to the low temperature end is a basic principle of the heat conduction, and a phenomenon as mentioned above is in circles. In addition, heat-dissipating efficiency of the heat pipe 72 is extremely high. For example, in the same temperature difference, heat-dissipating efficiency of the heat pipe 72 is at least 1000 times that of a metal rod. In the present invention, the plurality of thermal fins 74 is arranged perpendicularly to a direction of the heat pipe 72. A slot corresponding to a dimension and a shape of the heat pipe 72 is formed on the plurality of thermal fins 74 for installing the heat pipe 72. The plurality of thermal fins 74 can be arranged as lattices for increasing heat dissipating surfaces so as to conduct the heat conducted from the heat pipe 72 into surroundings. An interface between the heat pipe 72 and the plurality of radiation fins 74 can be coated with heat dissipating material for increasing conductive surfaces and for dissipating the heat effectively.

Please refer to FIG. 3. The first heat source 54 is disposed on the main board 52, such as the north bridge chip embedded on the main board 52, and the interface card 58 is inserted inside the slot 56 with a predetermined height distant from the main board 52. The predetermined height between the slot 56 and the main board 52 can be less than 15 mm. Therefore, a first height difference is formed between the first heat source 54 and the second heat source 60 of the interface card 58. The thermal module 62 can be installed between the main board 52 and the slot 56 so that the first side 661 of the first base plate 66 of the base 64 contacts with the first heat source 54 and the second side 681 of the second base plate 68 of the base 64 contacts with the second heat source 60, respectively. The heat conducted to the first base plate 66 from the first heat source 54 can be dissipated with the heat conduction, and the heat conducted to the second base plate 68 from the second heat source 60 can be dissipated with the heat conduction too. Thicknesses of the first base plate 66 and the second base plate 68 can be 1.5 mm, respectively. According to a stack mechanism of the first heat source 54, the first base plate 66 of the base 64, the second base plate 68 of the base 64, and the second heat source 60, a space between the interface card 58 and the main board 52 can be utilized effectively for installing the thermal module 62. The thermal module 62 can be used for dissipating the heat generated by a plurality of heating components simultaneously without disposing an exclusive thermal module for each heat source. Therefore, the present invention not only can utilize the space between the interface card 58 and the main board 52 effectively, but also can reduce amounts of heat dissipating components for cost down. Furthermore, if the present invention uses the north bridge chip as the first heat source 54 and the display card chip as the second heat source 60, the north bridge chip and the display card chip installed with the same thermal module 62 can have a preferred efficiency of heat dissipation due to the north bridge chip and the display card chip having contrary loadings in a same period while image processing. In addition, the base 64 can include a plurality of the base plates for contacting with the plurality of heat sources respectively so as to dissipate the heat generated by the plurality of heat sources simultaneously. The working principle is the same as the one mentioned according to above embodiment, and detail description is omitted herein for simplicity.

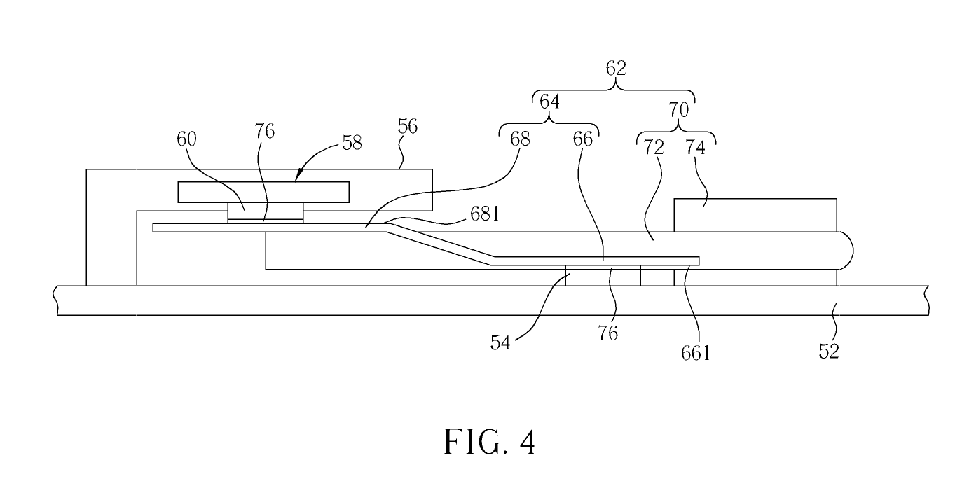

Besides, thermal pads can be disposed respectively between the first base plate 66 of the base 64 and the first heat source 54, and between the second base plate 68 and the second heat source 60 so as to increase efficiency of heat conduction. Please refer to FIG. 4. FIG. 4 is a sectional view of the thermal module 62 disposed between the first heat source 54 and the second heat source 60 according to a second embodiment of the present invention. A thermal pad 76 can be disposed respectively between the first base plate 66 of the base 64 and the first heat source 54, and between the second base plate 68 and the second heat source 60. The thermal pad 76 can be used for conducting the heat generated by the first heat source 54 to the first base plate 66 and for conducting the heat generated by the second heat source 60 to the second base plate 68 so as to increase the efficiency of heat conduction. The thermal pad 76 can be disposed selectively. That is to say, the thermal pad 76 can be merely disposed between the first base plate 66 and the first heat source 54, or can be merely disposed between the second base plate 68 and the second heat source 60.

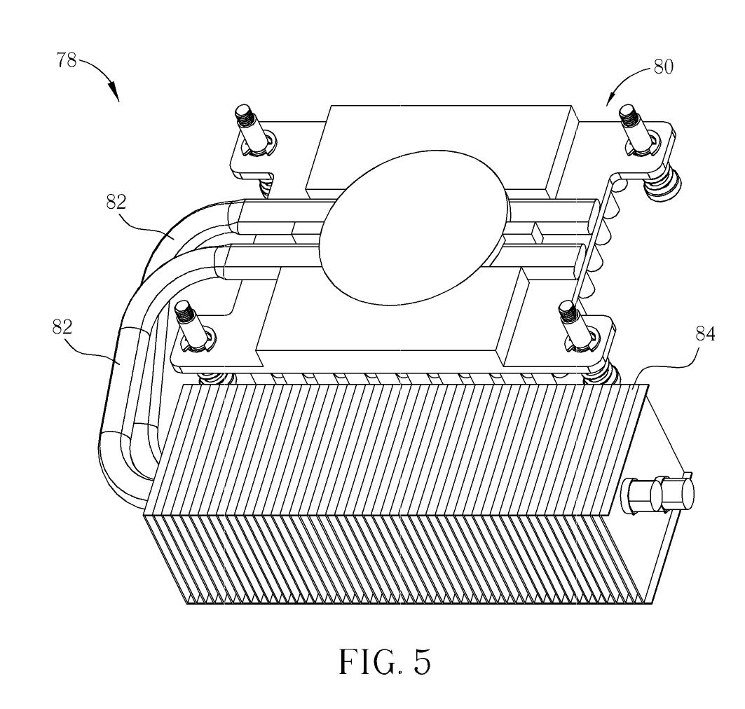

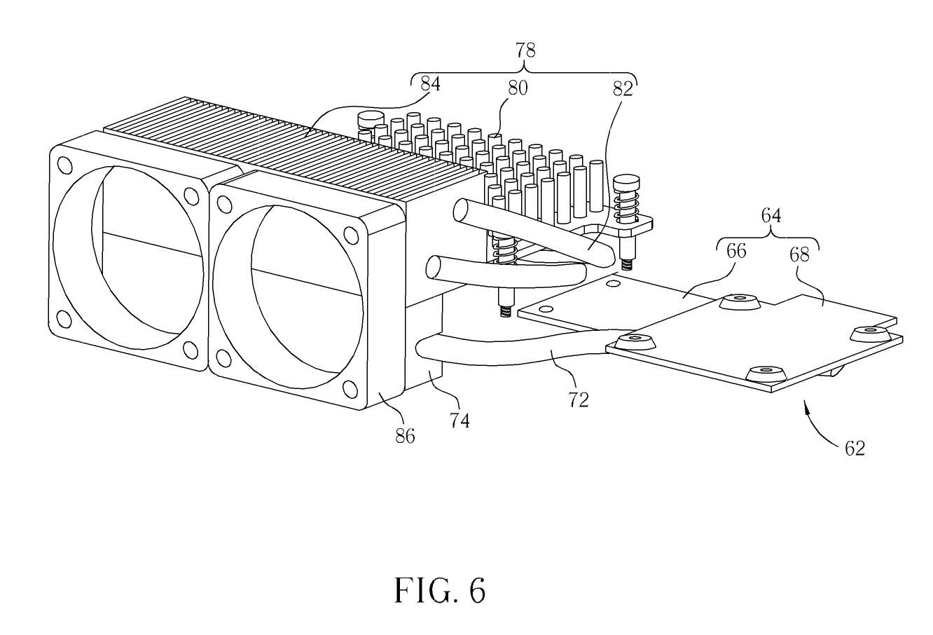

Please refer to FIG. 5 and FIG. 6. FIG. 5 is a schematic drawing of a central processing unit thermal module 78 of the present invention. FIG. 6 is a schematic drawing of the thermal module 62 and the central processing unit thermal module 78 of the present invention. The central processing unit thermal module 78 includes a heat sink 80 disposed on a top of the central processing unit 77 so as to dissipate heat generated by the central processing unit 77. The central processing unit thermal module 78 further includes at least one heat pipe 82 connected to the heat sink 80 at one end. The central processing unit thermal module 78 further includes a plurality of thermal fins 84 connected to the other side of the heat pipe 82 for dissipating heat conducted from the heat pipe 82. The heat pipe 82 can conduct the heat conducted to the heat sink 80 from the central processing unit 77 to the plurality of thermal fins 84. The plurality of thermal fins 84 can dissipate heat conducted from the heat pipe 82 into the surroundings. In addition, the thermal device 70 further includes at least one fan 86 disposed on a side of the plurality of thermal fins 74 of the thermal device 70 and the plurality of thermal fins 84 of the central processing unit thermal module 78. The fan 86 can be used for dissipating the heat conducted from the plurality of thermal fins 74 of the thermal device 70, and for dissipating the heat conducted from the plurality of thermal fins 84 of the central processing unit thermal module 78. That is to say, the thermal module 62 and the central processing unit thermal module 78 can utilize the single fan 86 as a heat dissipating component in common without adding extra fans for dissipating the heat generated from the first heat source 54, the second heat source 60, and the central processing unit 77, respectively. The present invention can economize a mechanism space and cost of components effectively.

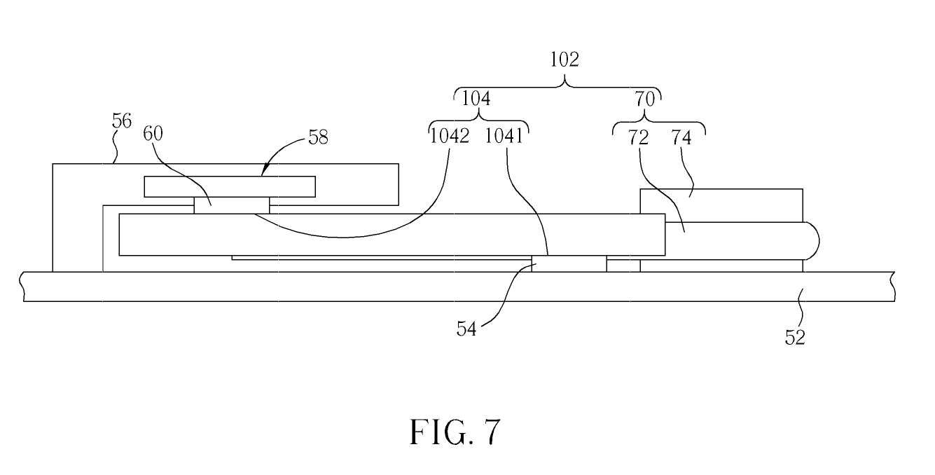

Please refer to FIG. 7. FIG. 7 is a sectional view of a thermal module 102 disposed between the first heat source 54 and the second heat source 60 according to a third embodiment of the present invention. The thermal module 102 includes a base 104. The base 104 can be a plate having uniform thickness, which is a single structure without height difference. The base 104 includes a first side 1041 for connecting to the first heat source 54 so as to conduct the heat generated by the first heat source 54, and a second side 1042 opposite to the first side 1041 for connecting to the second heat source 60 so as to conduct the heat generated by the second heat source 60. The base 104 can be made of metal material so as to increase the efficiency of heat conduction, such as copper and aluminum material. The thermal module 62 includes the heat dissipating device 70 connected to the base 104 for dissipating the heat conducted to the first side 1041 of the base 104 from the first heat source 54 and for dissipating the heat conducted to the second side 1042 of the base 104 from the second heat source 60. The thermal device 70 includes the heat pipe 72 connected to the base 104 at one end. The heat dissipating device 70 further includes the plurality of thermal fins 74 connected to the other end of the heat pipe 72 for dissipating heat conducted from the heat pipe 72. The working principle of the thermal module 102 is the same as the one mentioned according to above embodiment, and detailed description is omitted herein for simplicity.

In contrast to the prior art, the present invention utilizes the stack mechanism of different heat sources disposed on the base of the thermal module so as to economize the space between the interface card and the main board effectively for installing the thermal module. A set of the thermal module can be used for dissipating the heat generated by the plurality of heating components simultaneously without disposing the exclusive thermal module for individual heating component. Therefore, the present invention not only can utilize the mechanism space effectively, but can also reduce amounts of the heat dissipating components for cost down.

Those skilled in the art will readily observe that numerous modifications and alterations of the device and method may be made while retaining the teachings of the invention.

What is claimed is:

1. A thermal module comprising:
a base comprising:
a first side for connecting to a first heat source so as to conduct heat generated by the first heat source; and
a second side disposed opposite to the first side for connecting to a second heat source so as to conduct heat generated by the second heat source; and
a heat dissipating device connected to the base for dissipating the heat conducted to the first side of the base from the first heat source and for dissipating the heat conducted to the second side of the base from the second heat source;
wherein a first height difference is formed between the first heat source and the second heat source, and the base is disposed between the first heat source and the second heat source.

2. The thermal module of claim 1, wherein the base is made of metal material.

3. The thermal module of claim 2, wherein the base is made of copper or aluminum material.

4. The thermal module of claim 1, wherein the heat dissipating device further comprises:
a heat pipe connected to the base at an end.

5. The thermal module of claim 4, wherein the heat dissipating device further comprises:
a plurality of thermal fins connected to the other end of the heat pipe for dissipating heat conducted from the heat pipe.

6. The thermal module of claim 5, wherein the heat dissipating device further comprises:
a fan disposed on a side of the plurality of thermal fins for dissipating heat of the plurality of thermal fins.

7. The thermal module of claim 1, wherein the base comprises:
a first base plate whereon the first side is disposed; and
a second base plate whereon the second side is disposed, the second base plate being connected to the first base plate, and a second height difference being formed between the first base plate and the second base plate.

8. The thermal module of claim 1, wherein the first base plate is integrated with the second base plate monolithically.

9. A computer system comprising:
a main board;
a first heat source installed on the main board;
a slot disposed on a side of the main board;
an interface card for inserting into the slot, a second heat source being disposed on the interface card, and a first height difference being formed between the first heat source and the second heat source; and
a thermal module comprising:
a base disposed between the first heat source and the second heat source; the base comprising:
a first side for connecting to the first heat source so as to conduct heat generated by the first heat source; and
a second side disposed opposite to the first side for connecting to the second heat source so as to conduct the heat generated by the second heat source; and
a heat dissipating device connected to the base for dissipating the heat conducted to the first side of the base from the first heat source and for dissipating the heat conducted to the second side of the base from the second heat source.

10. The computer system of claim 9, wherein the first heat source is a chip.

11. The computer system of claim 10, wherein the first heat source is a north bridge chip.

12. The computer system of claim 9, wherein the slot is a display card slot, the interface card is a display card, and the second heat source is a display card chip.

13. The computer system of claim 9, wherein the base is made of metal material.

14. The computer system of claim 13, wherein the base is made of copper or aluminum material.

15. The computer system of claim 9, wherein the heat dissipating device comprises:
a heat pipe connected to the base at an end.

16. The computer system of claim 15, wherein the heat dissipating device further comprises:
a plurality of thermal fins connected to the other end of the heat pipe for dissipating heat conducted from the heat pipe.

17. The computer system of claim 16, wherein the heat dissipating device further comprises:
a fan disposed on a side of the plurality of thermal fins for dissipating heat of the plurality of thermal fins.

18. The computer system of claim 17, wherein the computer system further comprises:
a central processing unit thermal module disposed on a side of the fan and on a side of the plurality of thermal fins, the fan being used for dissipating heat of the plurality of thermal fins and the central processing unit thermal module.

19. The computer system of claim 9, wherein the computer system further comprises:
a first thermal pad installed between the first side of the base and the first heat source for conducting the heat generated by the first heat source to the first side of the base.

20. The computer system of claim 9, wherein the computer system further comprises:
a second thermal pad installed between the second side of the base and the second heat source for conducting the heat generated by the second heat source to the second side of the base.

21. The computer system of claim 9, wherein the base comprises:
a first base plate whereon the first side is disposed; and
a second base plate whereon the second side is disposed, the second base plate being connected to the first base plate, and a second height difference being formed between the first base plate and the second base plate.

22. The computer system of claim 9, wherein the first base plate is integrated with the second base plate monolithically.
